(19) United States
(12) Patent Application Publication
(10) Pub. No.: US 2016/0087774 A1
(43) Pub. Date: Mar. 24, 2016

(54) Method, system and device for selecting demodulation reference signal pattern information

(71) Applicant: ZTE CORPORATION, Guangdong (CN)

(72) Inventors: Senbao Guo, Shenzhen (CN); Yunfeng Sun, Shenzhen (CN); Junfeng Zhang, Shenzhen (CN); Zhisong Zuo, Shenzhen (CN)

(73) Assignee: ZTE CORPORATION, Shenzhen, Guangdong (CN)

(21) Appl. No.: 14/787,758

(22) PCT Filed: Apr. 14, 2014
(86) PCT No.: PCT/CN2014/075312

§ 371 Date: Oct. 28, 2015

(30) Foreign Application Priority Data
Apr. 28, 2013 (CN) 201310157543

(51) Int. Cl. H04L 5/00; H04W 72/12

(52) U.S. Cl. CPC H04L 5/0051; H04L 5/0094; H04W 72/1294

(57) ABSTRACT

Disclosed in the present invention are a method, a system and a device for selecting Demodulation Reference Signal (DMRS) pattern information, wherein the method includes that a base station selects DMRS pattern information on the basis of a preset first rule, and informs a terminal of the selected DMRS pattern information; and the base station sends a DMRS to the terminal according to the selected DMRS pattern information.

### TECHNICAL FIELD

The disclosure relates to the field of Long Term Evolution (LTE), and in particular to a method, a system and a device for selecting Demodulation Reference Signal (DMRS) pattern information.

### BACKGROUND

In LTE, a User Equipment (UE) receives downlink data transparently through a DMRS. The DMRS supports a dynamic and transparent switch between SU-MIMO (Single-User Multiple-Input Multiple-Output) and MU-MIMO (Multi-User Multiple-Input Multiple-Output), and an interference estimation which uses the DMRS is supported. Thus, the interference elimination performance at a receiving side can be improved greatly.

At present, in LTE R11, a DMRS pattern is only sent on an Orthogonal Frequency Division Multiplexing (OFDM) symbol 5 and an OFDM symbol 6, which causes that the accuracy of channel estimation of the first 5 OFDM symbols is decreased. Thus, a solution of advancing the DMRS OFDM symbol is proposed. However, the solution has a spectral efficiency gain only at a medium-high-speed high signal to noise ratio. In addition, in LTE, there is also a co-channel scenario of a compatible carrier and a new carrier, once the DMRS OFDM occupies the PDCCH OFDM of the compatible carrier, the PDCCH of the compatible carrier will cause a significant interference with the DMRS of the new carrier, thereby causing degradation of channel estimation performance and decrease of the average spectral efficiency of the system.

Thus, the DMRS pattern which is adopted for transmission of the DMRS in the prior art cannot ensure the transmission gain in all the different environments.

### SUMMARY

In view of this, the disclosure is intended to provide a method, a system and a device for selecting DMRS pattern information, which can select different DMRS pattern information to send a DMRS according to different environments, thereby ensuring the accuracy of channel estimation and the transmission performance.

The disclosure provides a method for selecting DMRS pattern information, which includes that:

a base station selects DMRS pattern information on the basis of a preset first rule, and informs a terminal of the selected DMRS pattern information; and

the base station sends a DMRS to the terminal according to the selected DMRS pattern information;

wherein, the first rule at least includes one of the followings: high layer signalling, a newly-added information bit in Downlink Control Information (DCI), an existing bit in DCI, a Modulation and Coding Scheme (MCS), a size of continuous Physical Resource Block (PRB) pairs allocated for the terminal, a size of Physical Resource Group (PRG), a mode of continuously scheduling sub-frames in time domain or a number of the continuously scheduled sub-frames, a system bandwidth, a carrier index, a carrier type, a carrier frequency, a start position of an OFDM symbol of a Physical Downlink Shared Channel (PDSCH), a start position of an OFDM symbol of an Enhanced Physical Downlink Control Channel (EPDCCH), a PDSCH RE Mapping and Quasi-Co-Location Indicator (PQI) based on a PDSCH, high layer signalling configuration based on a sub-frame cluster and a sub-frame type.

In the above solution, the DMRS pattern information at least includes one of the following information: a pattern of the DMRS, sequence information of the DMRS and port information of the DMRS.

In the above solution, before the base station selects the DMRS pattern information on the basis of the preset first rule, the method further includes that the base station and the terminal store one or more preset DMRS pattern information, respectively; or,

after the base station stores one or more preset DMRS pattern information, it sends all the preset DMRS pattern information to the terminal through the high layer signalling.

In the above solution, the base station informing the terminal of the selected DMRS pattern information on the basis of the preset rule includes that: the base station writes the selected DMRS pattern information into DL_Grant of a Physical Downlink Control Channel (PDCCH) or the EPDDCH, and sends the selected DMRS pattern information to the terminal.

In the above solution, writing the selected DMRS pattern information into the DL_Grant of the PDCCH or the EPDDCH may be writing the selected DMRS pattern information into a newly-added information bit or an existing information bit of the DL_Grant of the PDCCH or the EPDDCH.

In the above solution, the existing information bit of the DL_Grant is an MCS bit.

In the above solution, the base station selecting the DMRS pattern information on the basis of the preset first rule includes that one type of DMRS pattern information is selected from the preset DMRS pattern information according to a transmission rate of the PDSCH or a predefined rate.

In the above solution, the base station selecting the DMRS pattern information on the basis of the preset first rule includes that: the DMRS pattern information is selected according to the number of the allocated continuous PRB pairs; and/or

the DMRS pattern information is selected according to the size of PRG configured for the terminal.

In the above solution, the base station selecting the DMRS pattern information on the basis of the preset first rule includes that:

the DMRS pattern information is selected according to the mode of continuously scheduling the sub-frames in time domain configured for the terminal, or a mode of scheduling multiple sub-frames, or the number of sub-frames when scheduling the multiple sub-frames; and/or,

the DMRS pattern information is selected according to the current system bandwidth; and/or,

the DMRS pattern information is selected according to the carrier indexes corresponding to carriers currently configured for the terminal; and/or,

the DMRS pattern information is selected according to the current type of the carriers configured for the terminal; and/or,

the DMRS pattern information is selected according to the current frequency of the carriers configured for the terminal; and/or,

the DMRS pattern information is selected according to the start position of the OFDM symbol of the PDSCH sent to the terminal; and/or,

the DMRS pattern information is selected according to the start position of the OFDM symbol of the EPDCCH sent to the terminal; and/or,

the DMRS pattern information is selected according to a CSI-RS configured for the terminal; and/or,

the DMRS pattern information is selected according to a CSI process configured for the terminal; and/or,

the DMRS pattern information is selected according to PQI indication information and/or Nscid indication information configured for the terminal; and/or,

the DMRS pattern information is selected according to the sub-frame cluster configured for the terminal; and/or,

the DMRS pattern information is selected according to the sub-frame type configured for the terminal.

The disclosure also provides a method for selecting DMRS pattern information, which includes that:

the terminal selects the DMRS pattern information on the basis of a preset second rule; and

the terminal receives the DMRS from the base station according to the selected DMRS pattern information;

wherein the preset second rule includes at least one of the followings: the high layer signalling, the newly-added information bit in the DCI, the existing bit in the DCI, the MCS, the size of continuous PRB pairs allocated for the terminal, the size of PRG, the mode of continuously scheduling sub-frames in time domain or the number of continuously scheduled sub-frames, the system bandwidth, the carrier index, the carrier type, the carrier frequency, the start position of OFDM symbol of the PDSCH, the start position of OFDM symbol of the EPDCCH, the PQI based on the PDSCH, the high layer signalling configuration based on the sub-frame cluster and the sub-frame type.

In the above solution, the DMRS pattern information at least includes one of the following information: the pattern of the DMRS, the sequence information of the DMRS and the port information of the DMRS.

In the above solution, before the terminal selects the DMRS pattern information on the basis of the preset second rule, the method further includes that: the terminal stores one or more preset DMRS pattern information; or,

the terminal receives the preset DMRS pattern information sent by the base station through the high layer signalling.

In the above solution, the terminal selecting the DMRS pattern information on the basis of the preset second rule includes that: the terminal determines the DMRS pattern information to be used for receiving the DMRS according to the newly-added information bit or the existing information bit of DL_Grant of the PDCCH or the EPDDCH.

In the above solution, determining the DMRS pattern information to be used for receiving the DMRS according to the newly-added information bit or the existing information bit of DL_Grant of the PDCCH or the EPDDCH includes that: the terminal determines the DMRS pattern information to be used for receiving the DMRS according to the MCS bit of DL_Grant of the PDCCH or the EPDDCH.

In the above solution, the terminal selecting the DMRS pattern information on the basis of the preset second rule includes that: when the terminal determines, according to the MCS bit, that 256 Quadrature Amplitude Modulation (QAM) or a predefined rate of 256QAM is adopted to receive the PDSCH, the second of the two types of currently preset DMRS format information is adopted to receive the DMRS;

when the terminal determines, according to the MCS bit, that non-256QAM or a predefined rate of non-256QAM is adopted to receive the PDSCH, the first of the two types of currently preset DMRS format information is adopted to receive the DMRS.

In the above solution, the terminal selecting the DMRS pattern information on the basis of the preset second rule includes that: the terminal decides related information for receiving the DMRS according to the number of the allocated continuous PRB pairs; or, the terminal decides the related information for receiving the DMRS according to a resource allocation type and the size of PRG.

In the above solution, the terminal selecting the DMRS pattern information on the basis of the preset second rule includes that:

the terminal decides the related information for receiving the DMRS according to the mode of continuously scheduling the sub-frames in time domain or the mode of scheduling multiple sub-frames or the number of sub-frames when scheduling multiple sub-frames; and/or,

the terminal decides the related information for sending the DMRS according to the system bandwidth; and/or,

the terminal obtains the DMRS format information of a corresponding carrier by receiving corresponding DMRS format information which is configured separately by the high layer signalling for one or more carriers; and/or,

the terminal decides the DMRS format information for currently receiving a DMRS carrier by judging the type of configured carrier; and/or,

the terminal decides the DMRS format information for currently receiving the DMRS carrier by judging the frequency of configured carrier; and/or,

the terminal decides the DMRS format information for currently receiving the DMRS carrier according to the start position of the OFDM symbol of the PDSCH sent correspondingly; and/or,

the terminal decides the EPDCCH DMRS format information for currently receiving an EPDCCH DMRS carrier according to the start position of the OFDM symbol of the EPDCCH sent correspondingly; and/or,

the terminal obtains one or more CSI-RS through the high layer signalling, and obtains a piece of DMRS format information which is configured for each CSI-; the terminal decides the related information for receiving the DMRS according to the CSI-RS configured corresponding to the sub-frames; and/or,

the terminal obtains one or more CSI processes through the high layer signalling, and decides the related information for receiving the DMRS according to the CSI process configured corresponding to the sub-frames; and/or,

the terminal determines the DMRS format information according to the current PQI and/or Nscid indication information; and/or,

the terminal determines the DMRS format information according to the corresponding sub-frame cluster; and/or,

the terminal determines the DMRS format information according to the corresponding sub-frame type.

The disclosure also provides a method for selecting DMRS pattern information, which includes that:

the base station selects the DMRS pattern information on the basis of the preset first rule, and informs the terminal of the selected DMRS pattern information; the base station sends the DMRS to the terminal according to the selected DMRS pattern information; and

the terminal selects the DMRS pattern information on the basis of the preset second rule; the terminal receives the DMRS from the base station according to the selected DMRS pattern information.

The disclosure also provides a base station; the base station includes: a control module configured to select the DMRS pattern information on the basis of the preset first rule, and inform the terminal of the selected DMRS pattern information through a communication module; and

the communication module configured to send the DMRS to the terminal according to the selected DMRS pattern information;

wherein the preset first rule at least includes one of the followings: the high layer signalling, the newly-added information bit in the DCI, the existing bit in the DCI, the MCS, the size of continuous PRB pairs allocated for the terminal, the size of PRG, the mode of continuously scheduling sub-frames in time domain or the number of continuously scheduled sub-frames, the system bandwidth, the carrier index, the carrier type, the carrier frequency, the start position of OFDM symbol of the PDSCH, the start position of OFDM symbol of the EPDCCH, the PQI based on the PDSCH, the high layer signalling configuration based on the sub-frame cluster and the sub-frame type.

In the above solution, the base station further includes: a storage module, which is configured to store one or more preset DMRS pattern information; or,

the storage module is configured to, after storing one or more preset DMRS pattern information, send all the preset DMRS pattern information to be sent to the terminal through the high layer signalling to the control module; correspondingly, the control module is configured to send to the terminal all the DMRS pattern information which is sent from the storage module;

wherein the DMRS pattern information at least includes one of the following information: the pattern of the DMRS, the sequence information of the DMRS and the port information of the DMRS.

In the above solution, the control module is configured to write the selected DMRS pattern information into DL_Grant of the PDCCH or the EPDDCH, and send the selected DMRS pattern information to the terminal.

In the above solution, the control module is configured to write the selected DMRS pattern information into the newly-added information bit or the existing information bit of the DL_Grant of the PDCCH or the EPDDCH; wherein the existing information bit of the DL_Grant is: the MCS bit.

In the above solution, the control module is configured to select one from currently preset DMRS pattern information according to the transmission rate of the PDSCH or the predefined rate.

In the above solution, the control module is configured to select the DMRS pattern information according to the number of the currently allocated continuous PRB pairs; and/or,

the control module is configured to select the DMRS pattern information according to the size of PRG configured for the terminal.

In the above solution, the control module is configured to select the DMRS pattern information according to the mode of continuously scheduling the sub-frames in time domain configured for the terminal, or the mode of scheduling multiple sub-frames, or the number of sub-frames when scheduling multiple sub-frames; and/or,

the control module is configured to select the DMRS pattern information according to the current system bandwidth; and/or,

the control module is configured to select the DMRS pattern information according to the carrier indexes corresponding to carriers currently configured for the terminal; and/or,

the control module is configured to select the DMRS pattern information according to the type of the carriers currently configured for the terminal; and/or,

the control module is configured to select the DMRS pattern information according to the frequency of the carriers currently configured for the terminal; and/or,

the control module is configured to select the DMRS pattern information according to the start position of the OFDM symbol of the PDSCH sent to the terminal; and/or,

the control module is configured to select the DMRS pattern information according to the start position of the OFDM symbol of the EPDCCH sent to the terminal; and/or,

the control module is configured to select the DMRS pattern information according to the CSI-RS configured for the terminal; and/or,

the control module is configured to select the DMRS pattern information according to the CSI process configured for the terminal; and/or,

the control module is configured to select the DMRS pattern information according to the PQI indication information and/or the Nscid indication information configured for the terminal; and/or,

the control module is configured to select the DMRS pattern information according to the sub-frame cluster configured for the terminal; and/or,

the control module is configured to select the DMRS pattern information according to the sub-frame type configured for the terminal.

The disclosure also provides a terminal; the terminal includes: a processing module configured to select the DMRS pattern information on the basis of the preset second rule; and

a receiving module configured to receive the DMRS according to the DMRS pattern information;

wherein the preset second rule includes one of the followings: the high layer signalling, the newly-added information bit in the DCI, the existing bit in the DCI, the MCS, the size of continuous PRB pairs allocated for the terminal, the size of PRG, the mode of continuously scheduling sub-frames in time domain or the number of continuously scheduled sub-frames, the system bandwidth, the carrier index, the carrier type, the carrier frequency, the start position of OFDM symbol of the PDSCH, the start position of OFDM symbol of the EPDCCH, the PQI based on the PDSCH, the high layer signalling configuration based on the sub-frame cluster and the sub-frame type.

In the above solution, the terminal further include a storage module configured to store one or more preset DMRS pattern information; or the storage module is configured to store the DMRS pattern information sent from the receiving module.

In the above solution, the receiving module is configured to determine the DMRS pattern information to be used for receiving the DMRS according to the newly-added information bit or the existing information bit of the DL_Grant of the PDCCH or the EPDDCH.

In the above solution, the receiving module is configured to determine the DMRS pattern information to be used for receiving the DMRS according to the MCS bit of the DL_Grant of the PDCCH or the EPDDCH.

In the above solution, the receiving module is configured to, when determining, according to the MCS bit, that 256QAM or the predefined rate of 256QAM is adopted to receive the PDSCH, adopt the second of the two types of currently preset DMRS format information to receive the DMRS; the receiving module is further configured to, when determining according to the MCS bit that non-256QAM or the predefined rate of non-256QAM is adopted to receive the PDSCH, adopt the first of the two types of currently preset DMRS format information to receive the DMRS.

In the above solution, the receiving module is configured to decide the related information for receiving the DMRS according to the number of the allocated continuous PRB pairs; or, the receiving module is configured to decide the related information of receiving the DMRS according to the resource allocation type and the size of PRG.

In the above solution, the receiving module is configured to decide the related information for receiving the DMRS according to the mode of continuously scheduling the sub-frames in time domain or the mode of scheduling multiple sub-frames or the number of sub-frames when scheduling the multiple sub-frames; and/or,

the receiving module is configured to decide the related information of sending the DMRS according to the system bandwidth; and/or,

the receiving module is configured to obtain the DMRS format information of the corresponding carrier by receiving the corresponding DMRS format information which is configured separately by the high layer signalling for one or more carriers; and/or,

the receiving module is configured to decide the DMRS format information for currently receiving the DMRS carrier by judging the type of configured carrier; and/or,

the receiving module is configured to decide the current DMRS format information for currently receiving the DMRS carrier by judging the frequency of configured carrier; and/or,

the receiving module is configured to decide the current DMRS format information for currently receiving the DMRS carrier according to the start position of the OFDM symbol of the PDSCH sent correspondingly; and/or,

the receiving module is configured to decide the current EPDCCH DMRS format information for currently receiving the EPDCCH DMRS carrier according to the start position of the OFDM symbol of the EPDCCH sent correspondingly; and/or,

the receiving module is configured to obtain one or more CSI-RS through the high layer signalling, obtain a piece of DMRS format information configured for each CSI-RS, and decide the related information for receiving the DMRS according to the CSI-RS configured corresponding to the sub-frames; and/or,

the receiving module is configured to obtain one or more CSI processes through the high layer signalling, and decide the related information for receiving the DMRS according to the CSI process configured corresponding to the sub-frames; and/or,

the receiving module is configured to determine the DMRS format information according to the current PQI and/or Nscid indication information; and/or,

the receiving module is configured to determine the DMRS format information according to the corresponding sub-frame cluster; and/or,

the receiving module is configured to determine the DMRS format information according to the corresponding sub-frame type.

The disclosure provides a system for selecting DMRS pattern information, which includes: a base station in the above solutions and a terminal in the above solutions.

In the method, the system and the device for selecting DMRS pattern information provided by the disclosure, the base station informs the terminal of the selected DMRS pattern information on the basis of the preset rule, thereby sending the DMRS to the terminal through the selected DMRS pattern information. In this way, according to different system configurations and transmission configurations, the DMRS pattern information can be selected on the basis of multiple preset rules to send the DMRS, thereby ensuring the accuracy of channel estimation and the transmission performance.

### BRIEF DESCRIPTION OF THE DRAWINGS

FIG. 1 is a flowchart 1 of a method for selecting DMRS pattern information according to the disclosure;

FIG. 2 is a flowchart 2 of a method for selecting DMRS pattern information according to the disclosure;

FIG. 3 is a structural diagram of a system for selecting DMRS pattern information according to the disclosure;

FIG. 4 shows a DMRS pattern 1;

FIG. 5 shows a DMRS pattern 2;

FIG. 6 shows a DMRS pattern 3;

FIG. 7 shows a DMRS pattern 4;

FIG. 8 shows a DMRS pattern 5; and

FIG. 9 shows a DMRS pattern 6.

### DETAILED DESCRIPTION

The basic idea of the disclosure is that: the base station selects the DMRS pattern information on the basis of the preset first rule, and informs the terminal of the selected DMRS pattern information; and the base station sends the DMRS to the terminal according to the selected DMRS pattern information.

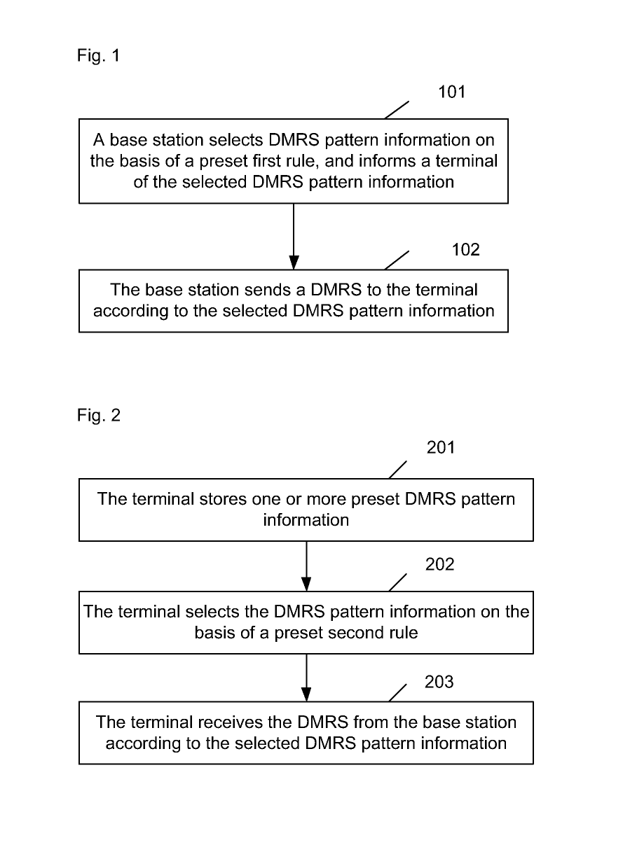

As shown in FIG. 1, a processing flow at the base station side in the method for selecting the DMRS pattern information according to the disclosure includes the following steps.

Step 101: The base station selects the DMRS pattern information on the basis of the preset first rule, and informs the terminal of the selected DMRS pattern information.

Herein, the preset first rule is that: the DMRS pattern information to be used is selected according to the different MCS; correspondingly, informing the terminal of the selected DMRS pattern information can be that: the selected DMRS pattern information is sent to the terminal through the high layer signalling, or the newly-added information bit in the DCI or the existing bit in the DCI; or,

the DMRS pattern information to be used is selected according to the size of continuous PRB pairs allocated for the terminal, or the size of PRG, or the mode of continuously scheduling sub-frames in time domain or the number of continuously scheduled sub-frames, or the system bandwidth, or the carrier index, or the carrier type, or the carrier frequency, or the start position of OFDM symbol of the PDSCH, or the start position of OFDM symbol of the EPDCCH, or the high layer signalling configuration based on the sub-frame cluster, or the sub-frame type. Or the DMRS pattern is configured according to the PQI based on the PDSCH.

Herein, selecting the DMRS pattern information to be used can be that: one is selected from the two types of currently preset DMRS pattern information according to the transmission rate of the PDSCH or the predefined rate; and/or,

the DMRS pattern information is selected according to the number of the currently allocated continuous PRB pairs; and/or,

the DMRS pattern information is selected according to the mode of continuously scheduling the sub-frames in time domain configured for the terminal, or the mode of scheduling multiple sub-frames, or the number of sub-frames when scheduling multiple sub-frames; and/or,

the DMRS pattern information is selected according to the current system bandwidth; and/or,

the DMRS pattern information is selected according to the current carrier index corresponding to carriers configured for the terminal; and/or,

the DMRS pattern information is selected according to the current type of the carriers configured for the terminal; and/or,

the DMRS pattern information is selected according to the current frequency of the carriers configured for the terminal; and/or,

the DMRS pattern information is selected according to the start position of the OFDM symbol of the PDSCH sent to the terminal; and/or,

the DMRS pattern information is selected according to the start position of the OFDM symbol of the EPDCCH sent to the terminal; and/or,

the DMRS pattern information is selected according to the CSI-RS configured for the terminal; and/or,

the DMRS pattern information is selected according to the CSI process configured for the terminal; and/or,

the DMRS pattern information is selected according to the PQI indication information and/or the Nscid indication information configured for the terminal; and/or,

the DMRS pattern information is selected according to the sub-frame cluster configured for the terminal; and/or,

the DMRS pattern information is selected according to the sub-frame type configured for the terminal.

Herein, the sub-frame type includes: Normal sub-frame and MBSFN sub-frame, or Normal sub-frame, TDD special sub-frame and so on; the sub-frame type in the disclosure is just for dividing wireless sub-frames into different types, and different DMRS pattern information can be adopted in different types of sub-frames, so the name of the sub-frame type has no limit to the idea of the disclosure.

Informing the terminal of the selected DMRS pattern information can also be that: the base station sends the selected DMRS pattern information to the terminal by writing the selected DMRS pattern information into DL_Grant of the PDCCH or the EPDDCH.

Herein, the bit in DL_Grant is: the newly-added information bit or the existing information bit in DL_Grant; the existing information bit in DL_Grant can be: the MCS bit.

Step 102: The base station sends the DMRS to the terminal according to the selected DMRS pattern information.

Preferably, before executing Step 101, the method can also include: the base station stores one or more preset DMRS pattern information.

Here, the DMRS pattern information at least includes one of the following information: the pattern of the DMRS, the sequence information of the DMRS and the port information of the DMRS.

Preferably, before the base station stores one or more preset DMRS pattern information, the base station can also send all the preset DMRS pattern information to the terminal through the high layer signalling. Herein, sending the preset DMRS pattern information to the terminal through the high layer signalling belongs to the prior art, so it will not be repeated here.

As shown in FIG. 2, a processing flow at the terminal in the method for selecting the DMRS pattern information that the disclosure presents includes the following steps.

Step 201: The terminal stores one or more preset DMRS pattern information.

Here, the one or more preset DMRS pattern information can be all the DMRS pattern information that is directly preset in the terminal according to the actual situation; the one or more preset DMRS pattern information can also be all the DMRS pattern information which is sent from the base station and received by the terminal.

Step 202: The terminal selects the DMRS pattern information on the basis of the preset second rule.

This step is specifically that: the terminal directly extracts the DMRS pattern information from the high layer signalling, or the newly-added information bit in the DCI, or the existing bit in the DCI or the MCS as the selected DMRS pattern information; or,

the DMRS pattern is configured according to the size of continuous PRB pairs configured by the base station, or the size of PRG, or the mode of continuously scheduling sub-frames in time domain or the number of continuously scheduled sub-frames, or the system bandwidth, or the carrier index, or the carrier type, or the carrier frequency, or the start position of OFDM symbol of the PDSCH, or the start position of OFDM symbol of the EPDCCH, or the PQI based on the PDSCH; or, the DMRS pattern information is selected according to the high layer signaling configuration based on the sub-frame cluster. This step can be that: one is determined from two types of the currently preset DMRS pattern information according to the transmission rate of the PDSCH or the predefined rate; and/or,

the DMRS pattern information is selected according to the number of the currently allocated continuous PRB pairs; and/or,

the DMRS pattern information is selected according to the mode of continuously scheduling the sub-frames in time domain, or the mode of scheduling multiple sub-frames, or the number of sub-frames when scheduling multiple sub-frames, which is configured by the base station; and/or,

the DMRS and/or, pattern information is selected according to the current system bandwidth;

the DMRS pattern information is selected according to the current carrier index corresponding to carriers configured by the base station; and/or,

the DMRS pattern information is selected according to the current type of the carriers configured for the terminal by the base station; and/or,

the DMRS pattern information is selected according to the current frequency of the carriers configured for the terminal by the base station; and/or,

the DMRS pattern information is selected according to the start position of the OFDM symbol of the PDSCH sent to the terminal by the base station; and/or,

the DMRS pattern information is selected according to the start position of the OFDM symbol of the EPDCCH sent to the terminal by the base station; and/or,

the DMRS pattern information is selected according to the CSI-RS configured for the terminal by the base station; and/or,

the DMRS pattern information is selected according to the CSI process configured for the terminal by the base station; and/or,

the DMRS pattern information is selected according to the PQI indication information and/or the Nscid indication information configured for the terminal by the base station; and/or,

the DMRS pattern information is selected according to the sub-frame cluster configured for the terminal by the base station; and/or,

the terminal selects the DMRS pattern information according to the corresponding sub-frame type.

Preferably, this step can also be that: the terminal obtains, from DL_Grant of the PDCCH or the EPDDCH, the DMRS pattern information which is selected by the base station. Herein, the bit in DL_Grant is: the newly-added information bit or the existing information bit in DL_Grant; the existing information bit in DL_Grant can be the MCS bit.

Preferably, this step can also be that: when the terminal adopts 256QAM or the predefined rate of 256QAM to receive the PDSCH, it selects the second of the two types of DMRS pattern information to receive the DMRS; when the terminal adopts non-256QAM or the predefined rate of non-256QAM to receive the PDSCH, it selects the first of the two types of DMRS pattern information to receive the DMRS.

Preferably, this step can also be that: the terminal decides the related information for receiving the DMRS according to the number of the allocated continuous PRB pairs. By defining that N numbers of the allocated continuous PRB pairs correspond to N DMRS pattern information, the corresponding DMRS pattern information is adopted to receive the DMRS when the different numbers of PRB pairs are allocated.

Preferably, this step can also be that: the terminal decides the related information freceiving the DMRS according to the resource allocation type and the size of PRG.

Preferably, this step can also be that: the terminal decides the related information of receiving the DMRS according to the mode of continuously scheduling the sub-frames in time domain or the mode of scheduling multiple sub-frames or the number of sub-frames when scheduling multiple sub-frames, and then receives the DMRS according to the corresponding DMRS pattern information.

Preferably, this step can also be that: the terminal decides the related information of sending the DMRS according to the system bandwidth, and then receives the DMRS according to the corresponding DMRS pattern information.

Preferably, this step can also be that: the terminal obtains the DMRS format information of the corresponding carrier by receiving the corresponding DMRS pattern information which is configured for one or more carriers separately by the high layer signalling. The terminal decides the current DMRS pattern information for receiving the DMRS carrier according to the carrier index, and then receives the DMRS according to the corresponding DMRS pattern information.

Preferably, this step can also be that: the terminal decides the current DMRS pattern information for receiving the DMRS carrier by judging the type of configured carrier, and then receives the DMRS according to the corresponding DMRS pattern information.

Preferably, this step can also be that: the terminal decides the current DMRS pattern information for receiving the DMRS carrier by judging the frequency of configured carrier, and then receives the DMRS according to the corresponding DMRS pattern information.

Preferably, this step can also be that: the terminal decides the current DMRS pattern information for receiving the DMRS carrier according to the start position of the OFDM symbol of the PDSCH sent correspondingly, and then receives the DMRS according to the corresponding DMRS pattern information.

Preferably, this step can also be that: the terminal decides the current EPDCCH DMRS pattern information for receiving the EPDCCH DMRS carrier according to the start position of the OFDM symbol of the EPDCCH sent correspondingly, and then receives the DMRS according to the corresponding DMRS pattern information.

Preferably, this step can also be that: the terminal obtains one or more CSI-RS through the high layer signalling, and obtains a piece of DMRS pattern information which is configured for each CSI-RS; the terminal decides the related information for receiving the DMRS according to the CSI-RS configured corresponding to the sub-frames, and then receives the DMRS according to the corresponding DMRS pattern information.

Preferably, this step can also be that: the terminal obtains one or more CSI processes through the high layer signalling, and obtains a piece of DMRS pattern information which is configured for each CSI process; the terminal decides the related information of sending the DMRS according to the CSI process configured corresponding to the sub-frames, and then receives the DMRS according to the corresponding DMRS pattern information.

Preferably, this step can also be that: the terminal obtains multiple pieces of configured PQI indication information through the high layer signalling, wherein each piece of PQI indication information configures the DMRS pattern information separately; the terminal obtains in the DCI Format 2D the PQI which is adopted to send a DMRS sub-frame, and receives the DMRS according to the DMRS pattern information corresponding to the current PQI and/or Nscid indication information.

Preferably, this step can also be that: the terminal obtains one or two configured sub-frame clusters through the high layer signalling; the terminal predefines or obtains the separate DMRS pattern information adopted at the different sub-frame clusters by receiving the high layer signalling configured by the base station; the terminal receives the DMRS at the corresponding sub-frame according to the DMRS pattern information corresponding to the corresponding sub-frame cluster.

Step 203: The terminal receives the DMRS from the base station according to the selected DMRS pattern information.

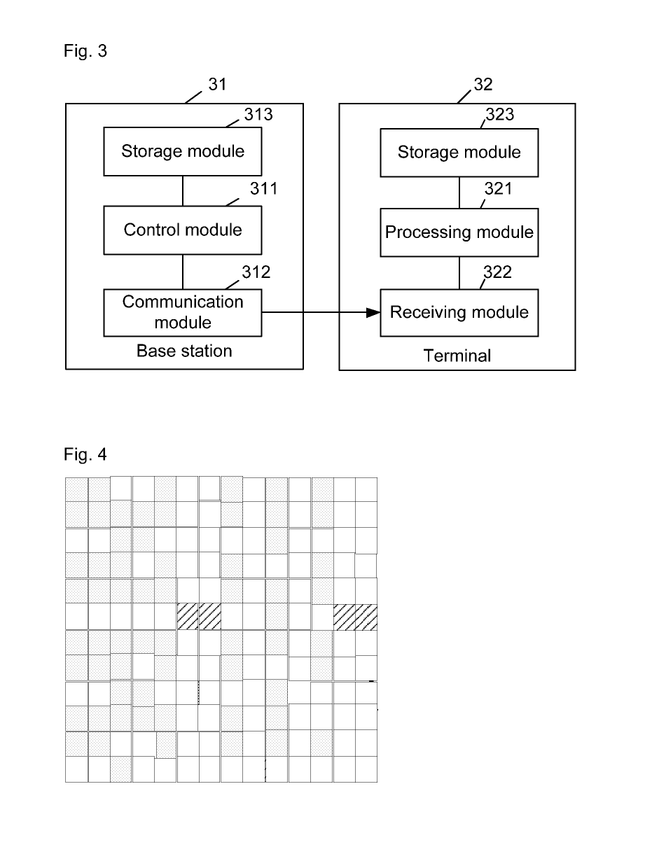

As shown in FIG. 3, the system for selecting DMRS pattern information includes a base station 31 and a terminal 32.

The base station 31 is configured to inform on the basis of a selecting rule the terminal of the selected DMRS pattern information to be used, and send the DMRS to the terminal through the selected DMRS pattern information.

The terminal 32 is configured to obtain on the basis of the selecting rule the DMRS pattern information to be used which is selected by the base station, and receive the DMRS from the base station according to the selected DMRS pattern information.

The base station 31 includes:

a control module 311 configured to select the DMRS pattern information on the basis of the preset first rule, and inform the terminal of the selected DMRS pattern information through a communication module; and

the communication module 312 configured to send the DMRS to the terminal according to the selected DMRS pattern information.

The base station further includes: a storage module 313 configured to store one or more preset DMRS pattern information; wherein, the DMRS pattern information at least includes one of the following information: the pattern of the DMRS, the sequence information of the DMRS and the port information of the DMRS.

The control module 311 is configured to send all the DMRS pattern information which is stored in the storage module to the terminal through the high layer signalling; correspondingly, the storage module 313 is configured to provide all the stored DMRS pattern information for the control module.

The control module 311 is configured to directly send the selected DMRS pattern information to be used according to the high layer signalling, or the newly-added information bit in the DCI, or the existing bit in the DCI or the MCS.

Or, the control module 311 is configured to configure the DMRS pattern according to the size of continuous PRB pairs allocated for the terminal, or the size of PRG, or the mode of continuously scheduling sub-frames in time domain or the number of continuously scheduled sub-frames, or the system bandwidth, or the carrier index, or the carrier type, or the carrier frequency, or the start position of OFDM symbol of the PDSCH, or the start position of OFDM symbol of the EPDCCH or the PQI based on the PDSCH, and select the DMRS pattern information to be used according to the high layer signaling configuration based on the sub-frame cluster.

The control module 311 is configured to select one from two types of the currently preset DMRS pattern information according to the transmission rate of the PDSCH or the predefined rate;

and/or, the control module is configured to select the DMRS pattern information according to the number of the currently allocated continuous PRB pairs;

and/or, the control module is configured to select the DMRS pattern information according to the mode of continuously scheduling the sub-frames in time domain, or the mode of scheduling multiple sub-frames, or the number of sub-frames when scheduling multiple sub-frames, which is configured for the terminal;

and/or, the control module is configured to select the DMRS pattern information according to the current system bandwidth;

and/or, the control module is configured to select the DMRS pattern information according to the current carrier index corresponding to carriers configured for the terminal;

and/or, the control module is configured to select the DMRS pattern information according to the current type of the carriers configured for the terminal;

and/or, the control module is configured to select the DMRS pattern information according to the current frequency of the carriers configured for the terminal;

and/or, the control module is configured to select the DMRS pattern information according to the start position of the OFDM symbol of the PDSCH sent to the terminal;

and/or, the control module is configured to select the DMRS pattern information according to the start position of the OFDM symbol of the EPDCCH sent to the terminal;

and/or, the control module is configured to select the DMRS pattern information according to the CSI-RS configured for the terminal;

and/or, the control module is configured to select the DMRS pattern information according to the CSI process configured for the terminal;

and/or, the control module is configured to select the DMRS pattern information according to the PQI indication information and/or the Nscid indication information configured for the terminal;

and/or, the control module is configured to select the DMRS pattern information according to the sub-frame cluster configured for the terminal;

and/or, the control module is configured to select the DMRS pattern information according to the sub-frame type configured for the terminal.

The control module 311 is configured to write the selected DMRS pattern information at the bit in DL_Grant of the PDCCH or the EPDDCH, and send the selected DMRS pattern information to the terminal.

Herein, the bit in DL_Grant is: the newly-added information bit or the existing information bit in DL_Grant; the existing information bit in DL_Grant may be the MCS bit.

The control module can be implemented by a CPU, a DSP and other hardware; the communication module can be implemented by the CPU, the DSP, an antenna and other hardware; and the storage module can be implemented by a memory.

The terminal 32 includes:

a processing module 321 configured to select the DMRS pattern information on the basis of the preset second rule;

a receiving module 322 configured to receive the DMRS according to the DMRS pattern information.

The terminal 32 further includes: a storage module 323 configured to store one or more preset DMRS pattern information.

The storage module 323 can be configured to directly store all the preset DMRS pattern information according to the actual situation.

The storage module 323 can also be configured to store all the DMRS pattern information which is received by the receiving module; correspondingly, the receiving module 322 is configured to send all the DMRS pattern information which is sent by the base station to the storage module.

The receiving module 322 is configured to directly extract the DMRS pattern information from the high layer signalling, or the newly-added information bit in the DCI, or the existing bit in the DCI or the MCS;

or, the receiving module is configured to configure the DMRS pattern according to the size of continuous PRB pairs configured by the base station, or the size of PRG, or the mode of continuously scheduling sub-frames in time domain or the number of continuously scheduled sub-frames, or the system bandwidth, or the carrier index, or the carrier type, or the carrier frequency, or the start position of OFDM symbol of the PDSCH, or the start position of OFDM symbol of the EPDCCH, or the PQI based on the PDSCH, and select the DMRS pattern information according to the high layer signalling configuration based on the sub-frame cluster.

The receiving module 322 is configured to determine one from two types of the currently preset DMRS pattern information according to the transmission rate of the PDSCH or the predefined rate;

and/or, the receiving module is configured to select the DMRS pattern information according to the number of the currently allocated continuous PRB pairs;

and/or, the receiving module is configured to select the DMRS pattern information according to the mode of continuously scheduling the sub-frames in time domain, or the mode of scheduling multiple sub-frames, or the number of sub-frames when scheduling multiple sub-frames, which is configured by the base station;

and/or, the receiving module is configured to select the DMRS pattern information according to the current system bandwidth;

and/or, the receiving module is configured to select the DMRS pattern information according to the current carrier index corresponding to carriers configured by the base station;

and/or, the receiving module is configured to select the DMRS pattern information according to the current type of the carriers configured for the terminal by the base station;

and/or, the receiving module is configured to select the DMRS pattern information according to the current frequency of the carriers configured for the terminal by the base station;

and/or, the receiving module is configured to select the DMRS pattern information according to the start position of the OFDM symbol of the PDSCH sent to the terminal by the base station;

and/or, the receiving module is configured to select the DMRS pattern information according to the start position of the OFDM symbol of the EPDCCH sent to the terminal by the base station;

and/or, the receiving module is configured to select the DMRS pattern information according to the CSI-RS configured for the terminal by the base station;

and/or, the receiving module is configured to select the DMRS pattern information according to the CSI process configured for the terminal by the base station;

and/or, the receiving module is configured to select the DMRS pattern information according to the PQI indication information and/or the Nscid indication information configured for the terminal by the base station;

and/or, the receiving module is configured to select the DMRS pattern information according to the sub-frame cluster configured for the terminal by the base station;

and/or, the receiving module is configured to select the DMRS pattern information according to the corresponding sub-frame type.

The receiving module is configured to obtain, from DL_Grant of the PDCCH or the EPDDCH, the DMRS pattern information which is selected by the base station. Herein, the bit in DL_Grant is: the newly-added information bit or the existing information bit in DL_Grant; the existing information bit in DL_Grant can be: the MCS bit.

The receiving module 322 is configured to, when adopting 256QAM or the predefined rate of 256QAM to receive the PDSCH, select the second of the two types of DMRS pattern information to receive the DMRS, and when adopting non-256QAM or the predefined rate of non-256QAM to receive the PDSCH, select the first of the two types of DMRS pattern information to receive the DMRS.

The receiving module 322 is configured to decide the related information of receiving the DMRS according to the number of the allocated continuous PRB pairs. By defining that N numbers of the allocated continuous PRB pairs correspond to N DMRS pattern information, the corresponding DMRS pattern information is adopted to receive the DMRS when the different numbers of PRB pairs are allocated.

The receiving module 322 is configured to decide the related information of receiving the DMRS according to the resource allocation type and the size of PRG.

The receiving module 322 is configured to decide the related information of receiving the DMRS according to the mode of continuously scheduling the sub-frames in time domain or the mode of scheduling multiple sub-frames or the number of sub-frames when scheduling multiple sub-frames, and then receive the DMRS according to the corresponding DMRS pattern information.

The receiving module 322 is configured to decide the related information of sending the DMRS according to the system bandwidth, and then receive the DMRS according to the corresponding DMRS pattern information.

The receiving module 322 is configured to obtain the DMRS format information of the corresponding carrier by receiving the corresponding DMRS pattern information which is configured for one or more carriers separately by the high layer signalling. The terminal decides the current DMRS pattern information of receiving the DMRS carrier according to the carrier index, and then receives the DMRS according to the corresponding DMRS pattern information.

The receiving module 322 is configured to decide the current DMRS pattern information of receiving the DMRS carrier by judging the type of configured carrier, and then receive the DMRS according to the corresponding DMRS pattern information.

The receiving module is configured to decide the current DMRS pattern information of receiving the DMRS carrier by judging the frequency of configured carrier, and then receive the DMRS according to the corresponding DMRS pattern information.

The receiving module 322 is configured to decide the current DMRS pattern information of receiving the DMRS carrier according to the start position of the OFDM symbol of the PDSCH sent correspondingly, and then receive the DMRS according to the corresponding DMRS pattern information.

The receiving module 322 is configured to decide the current EPDCCH DMRS pattern information of receiving the EPDCCH DMRS carrier according to the start position of the OFDM symbol of the EPDCCH sent correspondingly, and then receive the DMRS according to the corresponding DMRS pattern information.

The receiving module 322 is configured to obtain one or more CSI-RS through the high layer signalling, and obtain a piece of DMRS pattern information which is configured for each CSI-RS separately. The terminal decides the related information of receiving the DMRS according to the CSI-RS configured corresponding to the sub-frames, and then receives the DMRS according to the corresponding DMRS pattern information.

The receiving module 322 is configured to obtain one or more CSI processes through the high layer signalling, and obtain a piece of DMRS pattern information which is configured for each CSI-RS separately. The terminal decides the related information of sending the DMRS according to the CSI process configured corresponding to the sub-frames, and then receives the DMRS according to the corresponding DMRS pattern information.

The receiving module 322 is configured to obtain multiple pieces of configured PQI indication information through the high layer signalling, wherein each piece of PQI indication information configures the DMRS pattern information separately; the terminal obtains in the DCI Format 2D the PQI which is adopted to send a DMRS sub-frame, and receives the DMRS according to the DMRS pattern information corresponding to the current PQI and/or Nscid indication information.

The receiving module 322 is configured to obtain one or two configured sub-frame clusters through the high layer signalling; the terminal predefines or obtains the separate DMRS pattern information adopted at the different sub-frame clusters by receiving the high layer signalling configured by the base station; the terminal receives the DMRS at the corresponding sub-frame according to the DMRS pattern information corresponding to the corresponding sub-frame cluster.

The above processing module can be implemented by the CPU, the DSP and other hardware; the above receiving module can be implemented by the antenna and the CPU or the DSP and other hardware; and the storage module can be implemented by the memory.

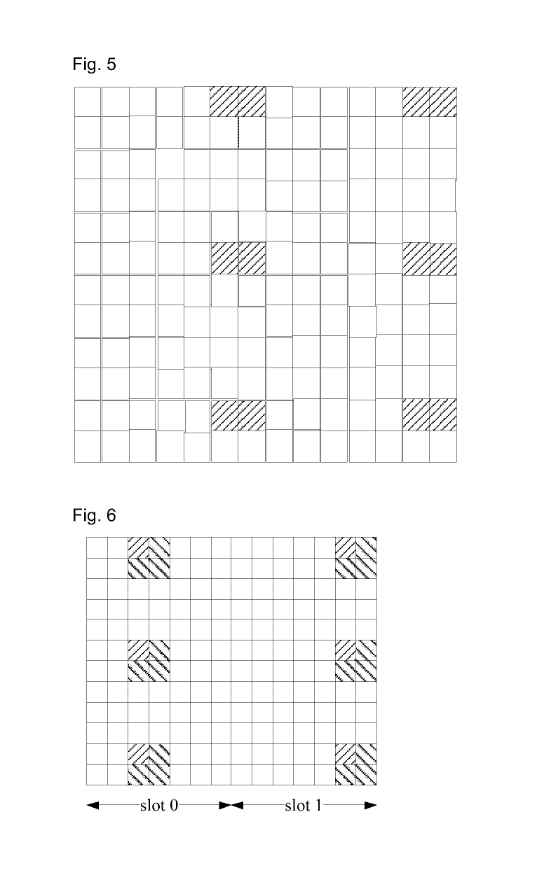

Embodiment 1: two DMRS patterns are predefined in the base station and the terminal, respectively, as shown in FIG. 4 and FIG. 5.

An operating process at the base station side is as follows.

The base station configures one or more types of DMRS pattern information for the terminal via the high layer signalling or in a predefinition manner. When the base station sends data to the terminal, it indicates, through the high layer signalling, the DMRS pattern adopted when the terminal receives the downlink data.

For example, when the terminal is in a low speed and low frequency selection scenario, the base station can configure for the terminal the DMRS pattern shown in FIG. 4 through the high layer signalling. Thus, the consumption of reference signal resources can be reduced, and the throughput of system is increased on the premise of ensuring the accuracy of DMRS estimation. When the terminal is in a high speed or high frequency selection scenario, the base station can configure for the terminal the DMRS pattern shown in FIG. 5 through the high layer signalling, which can ensure the accuracy of the DMRS in such scenario, thereby ensuring the stability of the throughput of system.

Or, the base station can select different DMRS patterns in a New Carrier Type (NCT) carrier according to the co-channel interference condition of the compatible carrier and the NCT carrier. When there is no co-channel interference between the NCT and the BCT (compatible carrier), the base station configures through the high layer signalling for the terminal the pattern shown in FIG. 5 to perform DMRS demodulation, which can increase the accuracy of channel estimation of the DMRS and increase the throughput of system. When there is co-channel interference between the NCT and the BCT, the base station configures through the high layer signalling for the terminal the pattern shown in FIG. 5 to perform DMRS demodulation, which can avoid the PDCCH of the BCT from interfering the DMRS, thereby increasing the accuracy of channel estimation of the DMRS and ensuring the stability of the throughput of system. Correspondingly, the terminal can obtain through the high layer signalling the DMRS pattern adopted when receiving the DMRS.

Or, the base station and the terminal predefine two EPDCCH DMRS patterns shown in FIG. 4 and FIG. 5. When the base station sends the EPDCCH to the terminal, it can configure through the high layer signalling one or more EPDCCH clusters for the terminal, and each EPDCCH cluster configures the DMRS pattern separately. For example, the base station configures two EPDCCH clusters for the terminal; the EPDCCH cluster 0 adopts the DMRS pattern shown in FIG. 5, and the EPDCCH cluster 1 adopts the DMRS pattern shown in FIG. 4. After the terminal receives the corresponding high layer signalling, it adopts the DMRS pattern shown in FIG. 5 to receive the EPDCCH cluster 0, and adopts the DMRS pattern shown in FIG. 4 to receive the EPDCCH cluster 1. Here, when the carrier co-channel between the BCT and the NCT can be realized better, the EPDCCH can be sent dynamically by the BCT or the NCT. Correspondingly, the terminal can obtain through the high layer signalling the DMRS pattern adopted when receiving the DMRS.

An operating process at the terminal side is as follows.

The terminal obtains through the high layer signalling the DMRS pattern adopted when receiving the DMRS. Herein, the high layer signalling includes deciding the DMRS pattern by configuring a transmission mode. For example, the transmission mode 11 is added. In this mode, the base station adopts the DMRS pattern shown in FIG. 4 to send the DMRS, and the terminal adopts the DMRS pattern shown in FIG. 4 to receive the DMRS.

Embodiment 2: two DMRS patterns are predefined in the base station and the terminal, respectively, as shown in FIG. 4 and FIG. 5.

When the base station sends data to the terminal, it indicates to the terminal the DMRS pattern sent by the base station in the current sub-frame by adding 1 bit in the DCI Format 2D, and indicates the DMRS pattern adopted when the terminal receives the DMRS. For example, at the sub-frame 0, because the interference to the terminal is less, it is feasible to indicate the terminal to adopt the DMRS pattern shown in FIG. 1 to receive the DMRS by setting a value of 1 bit as 0, which can increase the accuracy of DMRS estimation, and avoid collision with PSS/SSS. At the sub-frame 1, because the interference to the terminal is greater, it is feasible to indicate the terminal to adopt the DMRS pattern shown in FIG. 2 to receive the DMRS by setting a value of 1 bit as 1.

Embodiment 3: the base station and the terminal predefine two DMRS patterns; or the base station configures through the high layer signalling two DMRS patterns for the terminal. The base station dynamically indicates, through the existing bit of the PDCCH or the EPDCCH R11, the DMRS pattern adopted when the base station schedules the sub-frames to send the DMRS. Such processing can reduce standard effort, and reduce signalling overhead. The terminal receives the DMRS according to the informed DMRS pattern.

The base station and the terminal predefine two DMRS patterns shown in FIG. 4 and FIG. 5. When the base station sends data to the terminal, it decides the pattern of sending the DMRS by adopting a modulation mode corresponding to the MCS, and informs through the MCS the terminal of the DMRS pattern adopted when receiving the DMRS. For example, when the modulation mode corresponding to the MCS is QPSK/16QAM/64QAM, the base station adopts the DMRS pattern shown in FIG. 4 to send the DMRS, and the terminal adopts the DMRS pattern shown in FIG. 4 to receive the DMRS. When the modulation mode corresponding to the MCS is 256QAM or a certain rate of 256QAM, the base station adopts the DMRS pattern shown in FIG. 5 to send the DMRS, and the terminal adopts the DMRS pattern shown in FIG. 5 to receive the DMRS.

Or, when the number of the continuous PRB pairs allocated to a terminal by the base station is 3, the base station adopts the DMRS pattern in FIG. 5 to send the DMRS, and the terminal adopts the DMRS pattern in FIG. 5 to receive the DRMS. When the number of the continuous PRB pairs allocated to a terminal by the base station is 1, the base station adopts the DMRS pattern in FIG. 4 to send the DMRS, and the terminal adopts the DMRS pattern in FIG. 4 to receive the DRMS.

Embodiment 4: the base station and the terminal predefine three DMRS patterns;

and a relation between the current PRG and/or bandwidth and the selected DMRS pattern is preset in the base station and the terminal, respectively.

When the base station sends data to the terminal, it decides the selected DMRS pattern according to the size of the current PRG or the size of the bandwidth, and uses the selected DMRS pattern to send the DMRS to the terminal; the terminal decides the DMRS pattern adopted when receiving data according to the size of the current PRG or the size of the bandwidth.

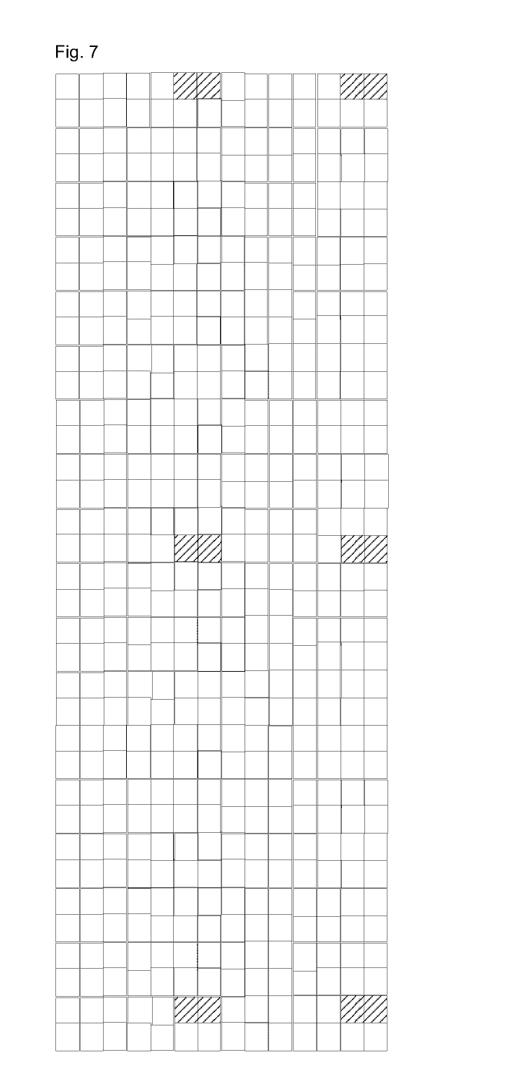

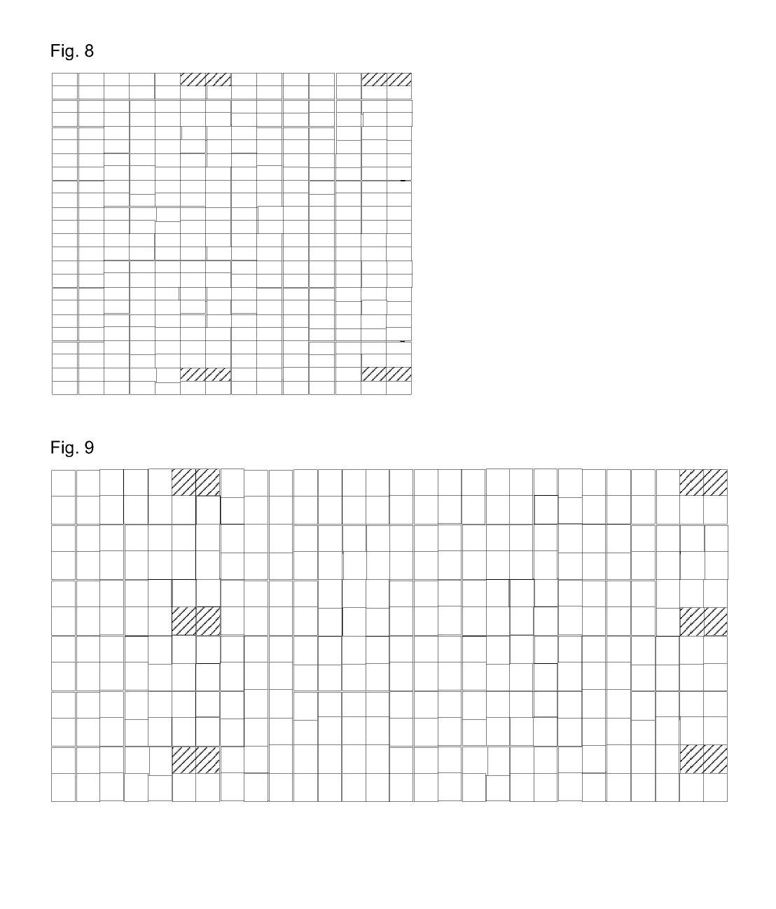

A corresponding relation between the PRG and the DMRS pattern is shown in the following table:

| System Bandwidth | RBG Size | |
|---|---|---|
| N_{RB}^{DL} | (P) | Pattern |
| ≦10 | 1 | FIG. 5 |
| 11-26 | 2 | FIG. 8 |
| 27-63 | 3 | FIG. 7 |
| 64-110 | 4 | FIG. 8 |

Embodiment 5: the base station configures for the terminal one or more types of DMRS pattern information by the high layer signalling or in a predefining manner, and decides the DMRS pattern of sending the DMRS according to whether to schedule multiple sub-frames or the number of sub-frames when scheduling multiple sub-frames. The terminal decides the DMRS pattern of receiving the DMRS according to whether to schedule multiple sub-frames or the number of sub-frames when scheduling multiple sub-frames.

The base station and the terminal predefine two DMRS patterns shown in FIG. 9 and FIG. 5; when the base station sends data to the terminal, it decides the DMRS pattern of sending the DMRS according to whether to schedule multiple sub-frames or the number of sub-frames when scheduling multiple sub-frames. The terminal decides the DMRS pattern of receiving the DMRS according to whether to schedule multiple sub-frames or the number of sub-frames when scheduling multiple sub-frames. For example, when the terminal is in the low speed and low frequency selection scenario, the base station can adopt the mode of scheduling multiple sub-frames to reduce control overhead, and then the base station adopts the DMRS pattern shown in FIG. 6 to send the DMRS. Thus, DMRS overhead is reduced as much as possible, and the throughput of system is increased on the premise of ensuring the accuracy of DMRS estimation. When the terminal is in the high speed or high frequency selection scenario, the base station can adopt a mode of scheduling single sub-frame to schedule the terminal, and then the base station adopts the DMRS pattern shown in FIG. 5 to send the DMRS, thus the stability of the throughput of system is ensured on the premise of ensuring the accuracy of DMRS estimation. The terminal judges the DMRS pattern adopted according to whether to adopt the mode of scheduling multiple sub-frames. When the terminal is informed of adopting the mode of scheduling multiple sub-frames, it adopts the DMRS pattern shown in FIG. 9 to receive the DMRS. When the terminal is informed of adopting the mode of scheduling single sub-frame, it adopts the DMRS pattern shown in FIG. 5 to receive the DMRS.

Embodiment 6: the base station adopts the high layer signalling to configure one or more carries for the terminal, and configures through the high layer signalling the DMRS patterns for more carries separately. When the base station sends data to the terminal at the corresponding carrier, it adopts the configured DMRS pattern to send the DMRS.

The terminal learns the DMRS patterns corresponding to one or more carriers by receiving the high layer signalling configured by the base station, and then judges the corresponding DMRS patterns according to the received carriers. For example, the terminal selects, according to the different carrier indexes, the corresponding DMRS patterns to receive the DMRS.

Embodiment 7: the base station adopts the high layer signalling to configure one or more carries for the terminal, and predefines that different DMRS patterns are adopted for different carrier frequency groups. When the base station sends data to the terminal at the corresponding carrier, it adopts the predefined DMRS pattern to send the DMRS.

The terminal learns the frequency of one or more carriers by receiving the high layer signalling configured by the base station and predefines the corresponding DMRS pattern, and then judges the corresponding DMRS pattern according to the received carrier frequency. For example, the terminal selects the corresponding DMRS pattern to receive the DMRS according to the different carrier frequencies.

For example, the DMRS pattern shown in FIG. 5 is adopted at the frequency band of 2G to 3G, which ensures the accuracy of DMRS channel estimation; and the DMRS pattern shown in FIG. 4 is adopted at the frequency band of 3.5G or a higher frequency band, which reduces DMRS overhead and increases the average throughput of system while ensuring the accuracy of channel estimation.

Embodiment 8: when the base station sends the EPDCCH to the terminal, the adopted EPDCCH DMRS pattern needs to be decided according to the start position of the OFDM symbol of the EPDCCH.

The base station configures the start position of the OFDM symbol separately for one or more EPDCCH clusters through the high layer signalling. When an OFDM symbol index at the start position of the EPDCCH is 0, 1 or 0, 1, 2, respectively, the DMRS pattern shown in FIG. 1 is adopted to send the DMRS. When the OFDM symbol index at the start position of the EPDCCH is 2, 3 or 3, 4, respectively, the DMRS pattern shown in FIG. 5 is adopted to send the DMRS.

The terminal learns the start position of the OFDM symbol of one or more EPDCCH clusters by receiving the high layer signalling. When the OFDM symbol index at the start position of the EPDCCH is 0, 1 or 0, 1, 2, respectively, the DMRS pattern shown in FIG. 1 is adopted to receive the DMRS. When the OFDM symbol index at the start position of the EPDCCH is 2, 3 or 3, 4, respectively, the DMRS pattern shown in FIG. 5 is adopted to receive the DMRS.

Embodiment 9: when the base station sends the PDSCH to the terminal, the adopted DMRS pattern needs to be decided according to the start position of the OFDM symbol of the PDSCH.

Because the OFDM start symbol of the PDSCH can be configured semi-statically or dynamically, the selection of the DMRS pattern can also be defined flexibly with the configuration of the start symbol of the PDSCH. When the PDSCH adopts the PQI to inform, the DMRS pattern can be changed according to the OFDM symbol index indicated in the PQI.

When the OFDM symbol index at the start position of the PDSCH is 0, 1 or 0, 1, 2, the base station adopts the DMRS pattern shown in FIG. 1 to send the DMRS. When the OFDM symbol index at the start position of the PDSCH is 2, 3, 4 or 3, 4, the base station adopts the DMRS pattern shown in FIG. 5 to send the DMRS.

When the OFDM symbol index at the start position of the PDSCH is 0, 1 or 0, 1, 2, the terminal adopts the DMRS pattern shown in FIG. 1 to receive the DMRS. When the OFDM symbol index at the start position of the PDSCH is 2, 3, 4 or 3, 4, the terminal adopts the DMRS pattern shown in FIG. 5 to receive the DMRS.

Embodiment 10: when the base station configures the transmission mode of the terminal as TM10, it configures one or more CSI-RS for the terminal, and separately configures the DMRS pattern corresponding to the one or more CSI-RS through the high layer signalling; the base station indirectly indicates the corresponding adopted DMRS pattern by indicating the CSI-RS corresponding to the current sub-frame.

For example, the base station configures three CSI-RS for the terminal, which are CSI-RS 0, CSI-RS 1 and CSI-RS 2, and configures that the CSI-RS 0 adopts the DMRS pattern shown in FIG. 1, the CSI-RS 1 adopts the DMRS pattern shown in FIG. 2, and the CSI-RS 2 adopts the DMRS pattern shown in FIG. 2. The base station sends a PQI indication bit existing in the DCI Format 2D. The configuration information of the corresponding CSI-RS included in each PQI state is used for indicating that the corresponding CSI-RS large-scale information (Doppler frequency domain, delay spread and so on) is adopted to perform the DMRS demodulation; at the same time, the PQI indication bit can be configured to indicate the DMRS pattern adopted when sending the DMRS.

The terminal obtains the corresponding DMRS pattern by receiving the high layer signalling configured by the base station and according to the CSI-RS configuration information in the received PQI, and receives the DMRS according to the corresponding DMRS pattern.

Embodiment 11: when the base station configures the transmission mode of the terminal as TM10, it configures one or more PQI information for the terminal, and separately configures the DMRS pattern corresponding to the one or more PQI information through the high layer signalling; the base station indirectly indicates the corresponding adopted DMRS pattern by indicating the PQI information corresponding to the current sub-frame.

For example, the base station configures three pieces of PQI information for the terminal, which are PQI information 0, PQI information 1 and PQI information 2, and configures that the PQI information 0 adopts the DMRS pattern shown in FIG. 1, the PQI information 1 adopts the DMRS pattern shown in FIG. 2, and the PQI information 2 adopts the DMRS pattern shown in FIG. 2. The base station sends the PQI indication bit existing in the DCI Format 2D, which is used for indicating the PQI information used by the current sub-frame; at the same time, the PQI indication bit can be configured to indicate the DMRS pattern adopted when sending the DMRS.

The terminal obtains the corresponding DMRS pattern by receiving the high layer signalling configured by the base station and according to the received PQI information, and receives the DMRS according to the corresponding DMRS pattern.

Embodiment 12: the base station configures two sub-frame clusters for the terminal, and predefines or configures through the high layer signalling that the separate DMRS pattern is adopted for the two sub-frame clusters, respectively.

The base station configures the sub-frame cluster 0 and the sub-frame cluster 1 for the terminal, and predefines that the base station adopts the DMRS pattern shown in FIG. 1 to send the DMRS at the sub-frame cluster 0, and adopts the DMRS pattern shown in FIG. 5 to send the DMRS at the sub-frame cluster 1. The terminal receives the sub-frame cluster 0 and the sub-frame cluster 1 configured by the base station through the high layer signalling, and predefines that the terminal adopts the DMRS pattern shown in FIG. 4 to receive the DMRS at the sub-frame cluster 0, and adopts the DMRS pattern shown in FIG. 5 to receive the DMRS at the sub-frame cluster 1.

### Embodiment 13

The base station configures the sub-frame cluster 0 and the sub-frame cluster 1 for the terminal, and separately configures through the high layer signalling that the sub-frame cluster 0 adopts the DMRS pattern shown in FIG. 4 to send the DMRS, and the sub-frame cluster 1 adopts the DMRS pattern shown in FIG. 5 to send the DMRS. The terminal receives the sub-frame cluster 0 and the sub-frame cluster 1 configured by the base station through the high layer signalling, and receives the high layer signalling by which the base station configures the DMRS pattern for the two sub-frame clusters; according to the configuration information of the high layer signalling, the terminal adopts the DMRS pattern shown in FIG. 4 to receive the DMRS at the sub-frame cluster 0, and adopts the DMRS pattern shown in FIG. 5 to receive the DMRS at the sub-frame cluster 1.

Embodiment 14: the base station and the terminal predefine two sub-frame types, and predefine or configure through the high layer signalling that the separate DMRS pattern is adopted for the two sub-frame types, respectively.

The base station configures the sub-frame type 0 and the sub-frame type 1 for the terminal, and predefines that the base station adopts the DMRS pattern shown in FIG. 1 to send the DMRS at the sub-frame type 0, and adopts the DMRS pattern shown in FIG. 5 to send the DMRS at the sub-frame type 1. The terminal adopts the DMRS pattern shown in FIG. 4 to receive the DMRS at the sub-frame type 0, and adopts the DMRS pattern shown in FIG. 5 to receive the DMRS at the sub-frame type 1.

The above is only the preferred embodiments of the disclosure, and not intended to limit the scope of the claims of the disclosure.

What is claimed is:

1. A method for selecting Demodulation Reference Signal (DMRS) pattern information, comprising:
selecting, by a base station, DMRS pattern information on the basis of a preset first rule, and informing a terminal of the selected DMRS pattern information; and
sending, by the base station, a DMRS to the terminal according to the selected DMRS pattern information;
wherein the first rule at least comprises one of the followings: a Modulation and Coding Scheme (MCS), a size of continuous Physical Resource Block (PRB) pairs allocated for the terminal, a size of Physical Resource Group (PRG), a mode of continuously scheduling sub-frames in time domain or a number of the continuously scheduled sub-frames, a system bandwidth, a carrier index, a carrier type, a carrier frequency, a start position of an Orthogonal Frequency Division Multiplexing (OFDM) symbol of a Physical Downlink Shared Channel (PDSCH), a start position of an OFDM symbol of an Enhanced Physical Downlink Control Channel (EPDCCH), a PDSCH RE Mapping and Quasi-Co-Location Indicator (PQI) based on a PDSCH, high layer signalling configuration based on a sub-frame cluster and a sub-frame type.

2. The method according to claim 1, wherein the DMRS pattern information at least comprises one of the following information: a pattern of the DMRS, sequence information of the DMRS and port information of the DMRS.

3. The method according to claim 2, further comprising: before selecting, by the base station, the DMRS pattern information on the basis of the preset first rule,
storing, by the base station and the terminal, one or more preset DMRS pattern information respectively; or
storing, by the base station, one or more preset DMRS pattern information, and sending, by the base station, all the stored preset DMRS pattern information to the terminal through high layer signalling.

4. The method according to claim 3, wherein the operation of informing the terminal of the selected DMRS pattern information comprises: writing, by the base station, the selected DMRS pattern information into DL_Grant of a Physical Downlink Control Channel (PDCCH) or an EPDDCH, and sending the selected DMRS pattern information to the terminal,
wherein the operation of writing the selected DMRS pattern information into the DL_Grant of the PDCCH or the EPDDCH comprises: writing the selected DMRS pattern information into a newly-added information bit or an existing information bit of the DL_Grant of the PDCCH or the EPDDCH,
wherein the existing information bit of the DL_Grant is an MCS bit.

5. (canceled)

6. (canceled)

7. The method according to claim 4, wherein the operation of selecting, by the base station, the DMRS pattern information on the basis of the preset first rule comprises: selecting one from the preset DMRS pattern information according to a transmission rate of the PDSCH or a predefined rate.

8. The method according to claim 4, wherein the operation of selecting, by the base station, the DMRS pattern information on the basis of the preset first rule comprises:
selecting the DMRS pattern information according to the number of the allocated continuous PRB pairs; and/or
selecting the DMRS pattern information according to the size of PRG configured for the terminal.

9. The method according to claim 3, wherein the operation of selecting, by the base station, the DMRS pattern information on the basis of the preset first rule comprises:
selecting the DMRS pattern information according to a mode of continuously scheduling the sub-frames in time domain configured for the terminal, or a mode of scheduling multiple sub-frames, or the number of sub-frames when scheduling the multiple sub-frames; and/or
selecting the DMRS pattern information according to a current system bandwidth; and/or
selecting the DMRS pattern information according to carrier indexes corresponding to carriers currently configured for the terminal; and/or
selecting the DMRS pattern information according to a type of carriers currently configured for the terminal; and/or
selecting the DMRS pattern information according to a frequency of carriers currently configured for the terminal; and/or
selecting the DMRS pattern information according to a start position of an OFDM symbol of a PDSCH sent to the terminal; and/or
selecting the DMRS pattern information according to a start position of an OFDM symbol of an EPDCCH sent to the terminal; and/or
selecting the DMRS pattern information according to a Channel State Indication Reference Signal (CSI-RS) configured for the terminal; and/or
selecting the DMRS pattern information according to a CSI process configured for the terminal; and/or
selecting the DMRS pattern information according to PQI indication information and/or Nscid indication information configured for the terminal; and/or
selecting the DMRS pattern information according to a sub-frame cluster configured for the terminal; and/or
selecting the DMRS pattern information according to a sub-frame type configured for the terminal.

10. A method for selecting Demodulation Reference Signal (DMRS) pattern information, comprising:
selecting, by a terminal, DMRS pattern information on the basis of a preset second rule; and
receiving, by the terminal, a DMRS from a base station according to the selected DMRS pattern information;
wherein the preset second rule comprises at least one of the followings: high layer signalling, a newly-added information bit in Downlink Control Information (DCI), an existing bit in the DCI, a Modulation and Coding Scheme (MCS), a size of continuous Physical Resource Block (PRB) pairs allocated for the terminal, a size of Physical Resource Group (PRG), a mode of continuously scheduling sub-frames in time domain or the number of the continuously scheduled sub-frames, a system bandwidth, a carrier index, a carrier type, a carrier frequency, a start position of an Orthogonal Frequency Division Multiplexing (OFDM) symbol of a Physical Downlink Shared Channel (PDSCH), a start position of an OFDM symbol of an Enhanced Physical Downlink Control Channel (EPDCCH), a PDSCH RE Mapping and Quasi-Co-Location Indicator (PQI) based on a PDSCH, high layer signalling configuration based on a sub-frame cluster and a sub-frame type.

11. The method according to claim 10, wherein the DMRS pattern information at least comprises one of the following information: a pattern of the DMRS, sequence information of the DMRS and port information of the DMRS.

12. The method according to claim 11, further comprising: before selecting, by the terminal, the DMRS pattern information on the basis of the preset second rule,
storing, by the terminal, one or more preset DMRS pattern information; or,
receiving, by the terminal, the preset DMRS pattern information sent by the base station through the high layer signalling.

13. The method according to claim 12, wherein the operation of selecting, by the terminal, the DMRS pattern information on the basis of the preset second rule comprises: determining, by the terminal, the DMRS pattern information to be used for receiving the DMRS according to a newly-added information bit or an existing information bit of DL_Grant of a Physical Downlink Control Channel (PDCCH) or an EPDDCH, wherein the existing information bit of the DL_Grant is an MCS bit.

14. (canceled)

15. The method according to claim 13, wherein the operation of selecting, by the terminal, the DMRS pattern information on the basis of the preset second rule comprises: when the terminal determines, according to the MCS bit, that 256 Quadrature Amplitude Modulation (QAM) or a predefined rate of 256QAM is adopted to receive the PDSCH, adopting the second of two types of currently preset DMRS format information to receive the DMRS; and
when the terminal determines, according to the MCS bit, that non-256QAM or a predefined rate of non-256QAM is adopted to receive the PDSCH, adopting the first of the two types of currently preset DMRS format information to receive the DMRS.

16. The method according to claim 13, wherein the operation of selecting, by the terminal, the DMRS pattern information on the basis of the preset second rule comprises: deciding, by the terminal, related information for receiving the DMRS according to the number of the allocated continuous PRB pairs;
or, deciding the related information for receiving the DMRS according to a resource allocation type and the size of PRG.

17. The method according to claim 10, wherein the operation of selecting, by the terminal, the DMRS pattern information on the basis of the preset second rule comprises:
deciding, by the terminal, related information for receiving the DMRS according to the mode of continuously scheduling the sub-frames in time domain or a mode of scheduling multiple sub-frames or the number of sub-frames when scheduling the multiple sub-frames; and/or,
deciding, by the terminal, related information for sending the DMRS according to the system bandwidth; and/or,
obtaining, by the terminal, DMRS format information for a corresponding carrier by receiving corresponding DMRS format information which is configured separately by the high layer signalling for one or more carriers; and/or,
deciding, by the terminal, DMRS format information for currently receiving a DMRS carrier by judging a type of a configured carrier; and/or,
deciding, by the terminal, DMRS format information for currently receiving a DMRS carrier by judging a frequency of a configured carrier; and/or,
deciding, by the terminal, DMRS format information for currently receiving a DMRS carrier according to a start position of an OFDM symbol of a PDSCH sent accordingly; and/or,
deciding, by the terminal, EPDCCH DMRS format information for currently receiving an EPDCCH DMRS carrier according to a start position of an OFDM symbol of an EPDCCH sent accordingly; and/or,
obtaining, by the terminal, one or more CSI-RS through the high layer signalling, and obtaining a piece of DMRS format information configured for each CSI-RS; and deciding related information for receiving the DMRS according to the CSI-RS configured corresponding to a sub-frame; and/or,
obtaining, by the terminal, one or more CSI processes through the high layer signalling, and deciding related information for receiving the DMRS according to the CSI process configured corresponding to a sub-frame; and/or,
determining, by the terminal, DMRS format information according to current PQI and/or Nscid indication information; and/or,
determining, by the terminal, DMRS format information according to a corresponding sub-frame cluster; and/or,
determining, by the terminal, DMRS format information according to a corresponding sub-frame type.

18. (canceled)

19. A base station, comprising:
a control module configured to select Demodulation Reference Signal (DMRS) pattern information on the basis of a preset first rule, and inform a terminal of the selected DMRS pattern information through a communication module;
the communication module configured to send a DMRS to the terminal according to the selected DMRS pattern information;
wherein, the preset first rule comprises one of the followings: a Modulation and Coding Scheme (MCS), a size of continuous Physical Resource Block (PRB) pairs allocated for the terminal, a size of Physical Resource Group (PRG), a mode of continuously scheduling sub-frames in time domain or a number of the continuously scheduled sub-frames, a system bandwidth, a carrier index, or a carrier type, a carrier frequency, a start position of an Orthogonal Frequency Division Multiplexing (OFDM) symbol of a Physical Downlink Shared Channel (PDSCH), a start position of an OFDM symbol of an Enhanced Physical Downlink Control Channel (EPDCCH), a PDSCH RE Mapping and Quasi-Co-Location Indicator (PQI) based on a PDSCH, high layer signalling configuration based on a sub-frame cluster and a sub-frame type.

20. The base station according to claim 19, further comprising: a storage module configured to store one or more preset DMRS pattern information; or,
the storage module is configured to, store the one or more preset DMRS pattern information, and send all the stored preset DMRS pattern information to be sent to the terminal through high layer signalling to the control module; accordingly, the control module is configured to send to the terminal all the DMRS pattern information which is sent from the storage module;
wherein, the DMRS pattern information at least comprises one of the following information: a pattern of the DMRS, sequence information of the DMRS and port information of the DMRS.

21. The base station according to claim 20, wherein,
the control module is configured to write the selected DMRS pattern information into DL_Grant of a Physical Downlink Control Channel (PDCCH) or an EPDDCH, and send the selected DMRS pattern information to the terminal through the communication module, wherein the selected DMRS pattern information is written into a newly-added information bit or an existing information bit of the DL_Grant and wherein the existing information bit of the DL_Grant is an MCS bit.

22. (canceled)

23. The base station according to claim 21, wherein,
the control module is configured to select one from currently preset DMRS pattern information according to a transmission rate of the PDSCH or a predefined rate.

24. The base station according to claim 23, wherein,
the control module is configured to select the DMRS pattern information according to the number of currently allocated continuous PRB pairs; and/or,
the control module is configured to select the DMRS pattern information according to the size of PRG configured for the terminal.

25. The base station according to claim 24, wherein,
the control module is configured to select the DMRS pattern information according to a mode of continuously scheduling the sub-frames in time domain configured for the terminal, or a mode of scheduling multiple sub-frames, or the number of sub-frames when scheduling the multiple sub-frames; and/or,
the control module is configured to select the DMRS pattern information according to a current system bandwidth; and/or,
the control module is configured to select the DMRS pattern information according to carrier indexes corresponding to carriers currently configured for the terminal; and/or,
the control module is configured to select the DMRS pattern information according to a type of carriers currently configured for the terminal; and/or,
the control module is configured to select the DMRS pattern information according to a frequency of carriers currently configured for the terminal; and/or,
the control module is configured to select the DMRS pattern information according to a start position of an OFDM symbol of a PDSCH sent to the terminal; and/or,
the control module is configured to select the DMRS pattern information according to a start position of an OFDM symbol of a EPDCCH sent to the terminal; and/or,
the control module is configured to select the DMRS pattern information according to a CSI-RS configured for the terminal; and/or,
the control module is configured to select the DMRS pattern information according to a CSI process configured for the terminal; and/or,
the control module is configured to select the DMRS pattern information according to PQI indication information and/or Nscid indication information configured for the terminal; and/or,
the control module is configured to select the DMRS pattern information according to a sub-frame cluster configured for the terminal; and/or,
the control module is configured to select the DMRS pattern information according to a sub-frame type configured for the terminal.

26. A terminal, comprising:
a processing module configured to select Demodulation Reference Signal (DMRS) pattern information on the basis of a preset second rule;
a receiving module configured to receive a DMRS according to the DMRS pattern information;
wherein, the preset second rule comprises at least one of the followings: high layer signalling, a newly-added information bit in Downlink Control Information (DCI), an existing bit in the DCI, a Modulation and Coding Scheme (MCS), a size of continuous Physical Resource Block (PRB) pairs allocated for the terminal, a size of Physical Resource Group (PRG), a mode of continuously scheduling sub-frames in time domain or the number of the continuously scheduled sub-frames, a system bandwidth, a carrier index, a carrier type, a carrier frequency, a start position of an Orthogonal Frequency Division Multiplexing (OFDM) symbol of a Physical Downlink Shared Channel (PDSCH), a start position of an OFDM symbol of an Enhanced Physical Downlink Control Channel (EPDCCH), a PDSCH RE Mapping and Quasi-Co-Location Indicator (PQI) based on the PDSCH, high layer signalling configuration based on a sub-frame cluster and a sub-frame type.

27. The terminal according to claim 26, further comprising: a storage module configured to store one or more preset DMRS pattern information; or, the storage module is configured to store the DMRS pattern information sent from the receiving module.

28. The terminal according to claim 27, wherein,
the receiving module is configured to determine the DMRS pattern information to be used for receiving the DMRS according to a newly-added information bit or an existing information bit of DL_Grant of a PDCCH or an EPDDCH, wherein the existing information bit of the DL_Grant is an MCS bit.

29. (canceled)

30. The terminal according to claim 28, wherein,
the receiving module is configured to, when determining, according to the MCS bit, to adopt 256 Quadrature Amplitude Modulation (QAM) or a predefined rate of 256QAM to receive the PDSCH, adopt the second of two types of currently preset DMRS format information to receive the DMRS; and
the receiving module is configured to, when determining, according to the MCS bit, to adopt non-256QAM or a predefined rate of non-256QAM to receive the PDSCH, adopt the first of two types of currently preset DMRS format information to receive the DMRS.

31. The terminal according to claim 30, wherein the receiving module is configured to decide related information for receiving the DMRS according to the number of the allocated continuous PRB pairs; or, the receiving module is configured to decide the related information of receiving the DMRS according to a resource allocation type and the size of PRG.

32. The terminal according to claim 26, wherein the receiving module is configured to decide related information for receiving the DMRS according to the mode of continuously scheduling the sub-frames in time domain or a mode of scheduling multiple sub-frames or the number of sub-frames when scheduling the multiple sub-frames; and/or,
the receiving module is configured to decide related information for sending the DMRS according to the system bandwidth; and/or,
the receiving module is configured to obtain DMRS format information for a corresponding carrier by receiving corresponding DMRS format information which is configured separately by the high layer signalling for one or more carriers; and/or,
the receiving module is configured to decide DMRS format information for currently receiving a DMRS carrier by judging a type of a configured carrier; and/or,
the receiving module is configured to decide DMRS format information for currently receiving a DMRS carrier by judging a frequency of a configured carrier; and/or,
the receiving module is configured to decide DMRS format information for currently receiving a DMRS carrier according to a start position of an OFDM symbol of a PDSCH sent accordingly; and/or,
the receiving module is configured to decide EPDCCH DMRS format information for currently receiving an EPDCCH DMRS carrier according to a start position of an OFDM symbol of an EPDCCH sent accordingly; and/or,
the receiving module is configured to obtain one or more CSI-RS through the high layer signalling, obtain a piece of DMRS format information configured for each CSI-RS, and decide related information for receiving the DMRS according to the CSI-RS configured corresponding to a sub-frame; and/or,
the receiving module is configured to obtain one or more CSI processes through the high layer signalling, and decide related information for receiving the DMRS according to the CSI process configured corresponding to a sub-frame; and/or,
the receiving module is configured to determine DMRS format information according to current PQI and/or Nscid indication information; and/or,
the receiving module is configured to determine DMRS format information according to a corresponding sub-frame cluster; and/or,
the receiving module is configured to determine DMRS format information according to a corresponding sub-frame type.

33. (canceled)
